(19) United States
(12) Patent Application Publication
(10) Pub. No.: US 2024/0377060 A1
(43) Pub. Date: Nov. 14, 2024

(54) Multi-Function Burner and Method of Operation

(71) Applicant: Air Products and Chemicals, Inc., Allentown, PA (US)

(72) Inventors: Mark Daniel D'Agostini, Allentown, PA (US); Henry Choisun Chan, Bellaire, TX (US); Shihong Yan, Sugar Land, TX (US); Zhong Zhou, Houston, TX (US)

(73) Assignee: Air Products and Chemicals, Inc., Allentown, PA (US)

(21) Appl. No.: 18/659,061

(22) Filed: May 9, 2024

Related U.S. Application Data
(60) Provisional application No. 63/465,291, filed on May 10, 2023.
(60) Provisional application No. 63/534,914, filed on Aug. 28, 2023.

(51) Int. Cl. F23D 14/32; F23D 14/58

(52) U.S. Cl. CPC F23D 14/32; F23D 14/58; F23D 2200/00; F23D 2207/00; F23D 2213/00; F23D 2900/00008

(57) ABSTRACT

A method for heating reactor using a multi-function burner comprising feeding primary fuel through an annular channel, feeding oxygen through a central channel within the annular channel, and feeding an auxiliary fuel through a central lance within the central channel to produce a flame extending into a furnace having a temperature and a pressure; wherein the flow rate of the auxiliary fuel and oxygen are increased while maintaining an equivalence ratio below 1 to increase the temperature of the furnace; wherein after the furnace temperature exceeds the auto-ignition temperature of the primary fuel, increasing the flow rate of the primary fuel to increase the equivalence ratio to be greater than 1.

### CROSS-REFERENCE TO RELATED APPLICATIONS

The present application claims priority to U.S. Provisional Patent Application No. 63/465,291 filed on May 10, 2023 and 63/534,914 filed on Aug. 28, 2023.

### BACKGROUND OF THE INVENTION

The present disclosure relates to a system and method of operation for a multi-function burner in a partial oxidation (POx) reactor. POx reactors convert hydrocarbons to synthesis gas, or syngas, at an oxygen to fuel molar ratio well below stoichiometric proportion and typically at elevated pressure and temperature. Most POx reactors must first undergo a heating mode, in which the reactor is slowly heated to avoid cracking or other damage in the refractory material lining the walls, before entering an oxy-fuel mode, in which the POx reactor generates syngas. Because the reactor heating occurs at atmospheric pressure, this introduces a design mismatch for the burner between the heating mode and the oxy-fuel mode. Typically separate burners are used for these two modes and swapped when the POx reactor reaches an elevated temperature, for example 1100-1400° C. Considering the significant challenges both in terms of safety and maintenance presented by swapping burners at high temperatures, there is a business need for a single burner that can operate in both modes.

### BRIEF DESCRIPTION OF DRAWINGS

The present invention will hereinafter be described in conjunction with the appended figures wherein like numerals denote like elements:

FIG. 1 is a cross-sectional side schematic view of an oxy-fuel burner according to the prior art.

FIG. 2 is a cross-sectional side schematic view of a multi-function burner with a central lance in a heating mode configuration.

FIG. 3 is a cross-sectional side schematic view of a multi-function burner with a central lance in a oxy-fuel mode configuration.

FIG. 4A is a cross-sectional side schematic view of a multi-function burner with a two-channel lance in a heating mode configuration.

FIG. 4B is a modification of FIG. 4A in which swirl vanes are positioned in the annulus between a central channel and the two-channel lance.

FIG. 4C is a cross-sectional side schematic view of the multi-function burner of FIG. 4B showing the effect of the swirl vanes on recirculation zones in the flame.

FIG. 4D1 is a modification of FIG. 4A in which swirl vanes are offset from the two channel lance by an annular bypass gap.

FIG. 4D2 is a cross-sectional side schematic view zoomed in on the tip of the burner shown in FIG. 4D2.

FIG. 4E is a cross-sectional side schematic view of the multi-function burner of FIG. 4C showing the effect of the swirl vanes on recirculation zones in the flame.

FIG. 5 is a cross-sectional side schematic view of a multi-function burner defining key geometric parameters.

FIG. 6 is a cross-sectional side schematic view of a multi-function burner with a central lance and a drive mechanism to move the central lance axially relative to the central channel.

FIG. 7 is a picture of a drive mechanism to move the central lance axially relative to the central channel.

FIG. 8A is a cross-sectional side schematic view of a multi-function burner with swirl vanes defining key geometric parameters.

FIG. 8B is a modification of FIG. 8A in which the central lance has a single channel and is withdrawn from the outlet of the central channel.

FIG. 9 is a cross-sectional side schematic view of a multi-function burner with a central lance operated with two fuel feed streams.

FIG. 10 is a cross-sectional side schematic view of a multi-function burner with swirl vanes operated with one gaseous fuel feed stream and one solid and/or liquid fuel feed stream.

FIG. 11 is a cross-sectional side schematic view of swirl vanes in a channel for an air-fuel burner.

FIG. 12 is a modification of FIG. 11 in which the swirl vanes are applied to an inverse diffusion oxy-fuel burner.

FIG. 13 is a cross-sectional side schematic view of swirl vanes in a converging channel.

FIG. 14 is a plot of the streamlines for a flow field with a swirling jet having a strong swirl.

FIG. 15 is a modification of FIG. 13 in which bleed holes located upstream of the swirl vanes allow a portion of the fluid flow to bypass the swirl vanes.

FIG. 16 is a modification of FIG. 15 in which the swirl vanes have a varying swirl angle along the length of the vanes.

FIG. 17 is a diagram showing a flame generated by an oxy-fuel burner demonstrating inner and outer flame portions.

FIG. 18 is a diagram showing a flame generated by an oxy-fuel burner demonstrating clearance of an inner flame with respect to the central channel.

FIG. 19 is a diagram showing a flame generated by an oxy-fuel burner demonstrating lift-off from the exit plane of the burner.

FIG. 20 is a plot showing a wall temperature in the burner as a function of equivalence ratio for three different swirl conditions.

### DETAILED DESCRIPTION OF THE INVENTION

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. Various changes may be made in the function and arrangement of elements without departing from the spirit and scope of the invention, as set forth in the appended claims.

The articles “a” or “an” as used herein mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

The term “and/or” placed between a first entity and a second entity includes any of the meanings of (1) only the first entity, (2) only the second entity, or (3) the first entity and the second entity. The term “and/or” placed between the last two entities of a list of 3 or more entities means at least one of the entities in the list including any specific combination of entities in this list. For example, “A, B and/or C” has the same meaning as “A and/or B and/or C” and comprises the following combinations of A, B and C: (1) only A, (2) only B, (3) only C, (4) A and B but not C, (5) A and C but not B, (6) B and C but not A, and (7) A and B and C.

“Downstream” and “upstream” refer to the intended flow direction of the process fluid transferred. If the intended flow direction of the process fluid is from the first device to the second device, the second device is downstream of the first device. In case of a recycle stream, downstream and upstream refer to the first pass of the process fluid.

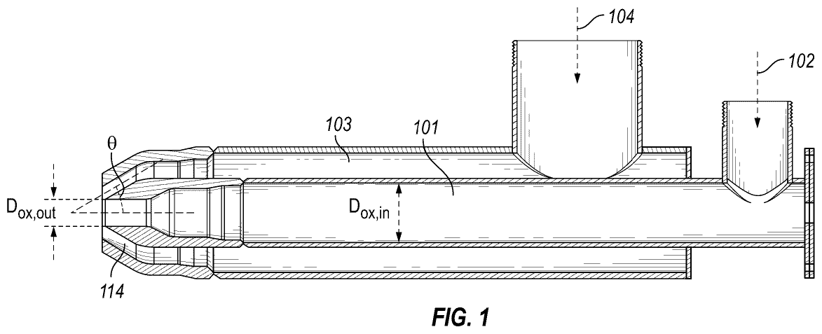

FIG. 1 shows a cross-sectional side schematic view of an oxy-fuel burner according to the prior art. A central channel 101 supplying oxygen 102 is surrounded by an annular channel 103 supplying a primary fuel 104 comprising one or more hydrocarbons such as natural gas or any gaseous, liquid, or solid hydrocarbons. An outlet 114 of the annular channel 103 forms an converging angle θ with the central axis of the oxy-fuel burner. The central channel may narrow from an inlet diameter D_{ox,in} to an outlet diameter D_{ox,out}. This configuration is known as an inverse diffusion flame in which the fuel surrounds the oxygen, commonly seen in POx burners. Those skilled in the art will understand that an oxy-fuel burner designed according to the prior art for high pressure at sub-stoichiometric conditions is not capable of delivering heat at a sufficiently low and stable rate during heat up of the reactor from cold conditions to temperatures in excess of 1200 deg C. at ambient pressure without potentially doing irreparable damage to furnace refractory. Common practice is therefore to utilize a separate “heating mode” air-fuel burner designed for providing a controlled temperature ramp at nominally atmospheric pressure, then physically removing this burner and replacing with an oxy-fuel burner similar to that of FIG. 1.

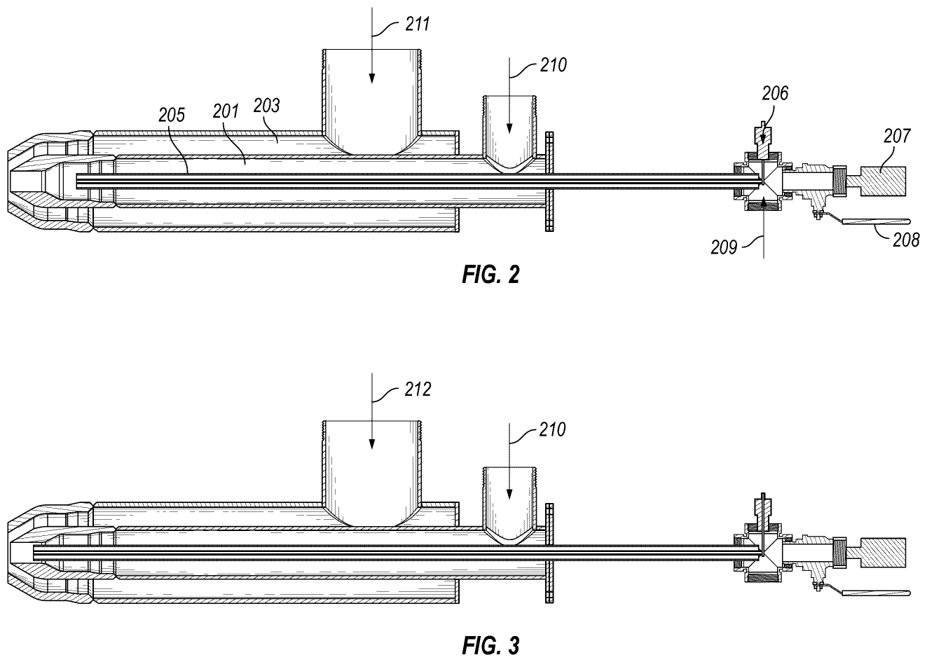

FIG. 2 shows a cross-sectional side schematic view of a multi-function burner according to the present disclosure with a central lance 205 along the axis of the central channel 201. The converging angle the outlet of the annular channel with respect to the central axis of the burner, θ, may be less than about 45°, or less than about 40°, or less than about 35°, or less than about 30°, or less than about 15°. The converging angle of the outlet of the annular channel with respect to the central axis of the burner, θ, may range from 5° to 45°, or from 10° to 40°, or from 15° to 30°. The outlet of the central lance 205 may extend near the tip of the central channel 201, or may be withdrawn to within a larger inner diameter region of the central channel 201 (for example, in the D_{ox,in} section as seen in FIG. 1). The central lance 205 allows the multi-function burner to operate in both heating mode and oxy-fuel mode. To assist in heating mode, the central lance 205 may comprise an ignition source 206 such as a high-voltage electrical device that generates a corona discharge (spark) from the central lance 205 to the central channel 201. The tip of the ignition source 206 may be bent towards the tip of the outlet of the central lance 205 to aid in forming an electrical arc (not shown). The central lance 205 may comprise a flame scanning device 207 that has a line of sight along the length of the central lance 205 to detect a flame in the multi-function burner. If the flame scanning device 207 is only required during heating mode, the flame scanning device may be isolated from the POx burner using an isolation valve 208 during oxy-fuel mode.

FIG. 2 shows the flow configuration for heating mode. In heating mode the central lance 205 feeds a heating fuel 209 such as natural gas, typically at a flow rate substantially less than required in oxy-fuel mode. The ignition source 206 may be used to ignite the fuel-oxygen mixture to produce a flame and the flame scanning device 207 may monitor the flame. Oxygen 210 may be provided through the central channel 201 and air 211 may be provided through the annular channel 203.

FIG. 3 shows the flow configuration for oxy-fuel mode once the required temperature in the POx reactor has been achieved. Flow through the central lance 205 may be cut off and the flame scanning device 207 may be isolated by closing one or more isolation valves 208. The central lance 205 may be purged with an inert gas. Oxygen 210 may still be provided through the central channel 201 but the primary fuel source 212 may be provided through the annular channel 203. During oxy-fuel mode the central lance 205 may be withdrawn into a larger diameter section of the central channel 201 as shown in FIG. 2.

It will be appreciated to a person of skill in the art that the switching of air to primary fuel in the annular channel 203 requires careful design to ensure safe operation. Check valves may be used to prevent backflow into the sources of fuel, air, and/or purge gas. Ball valves may allow isolation and purging of the sources of oxygen, fuel, air, and/or purge gas.

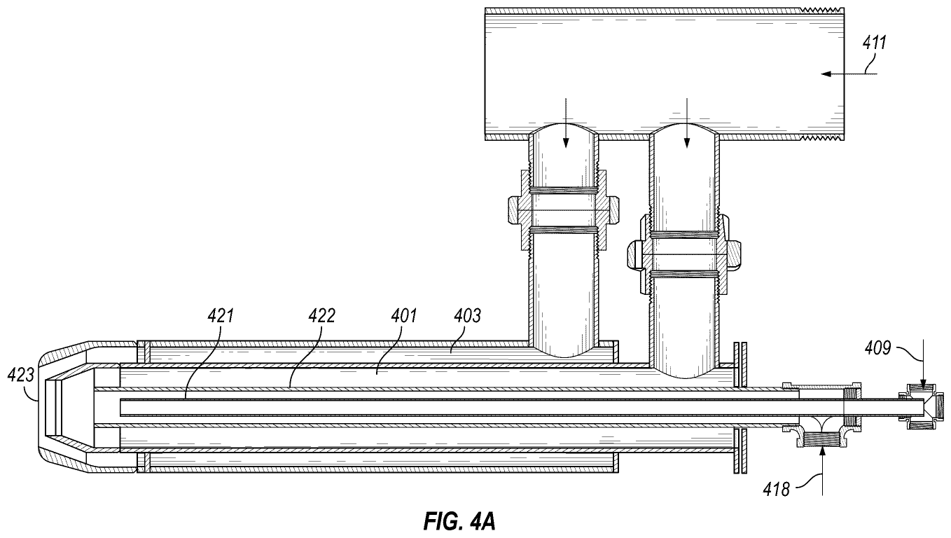

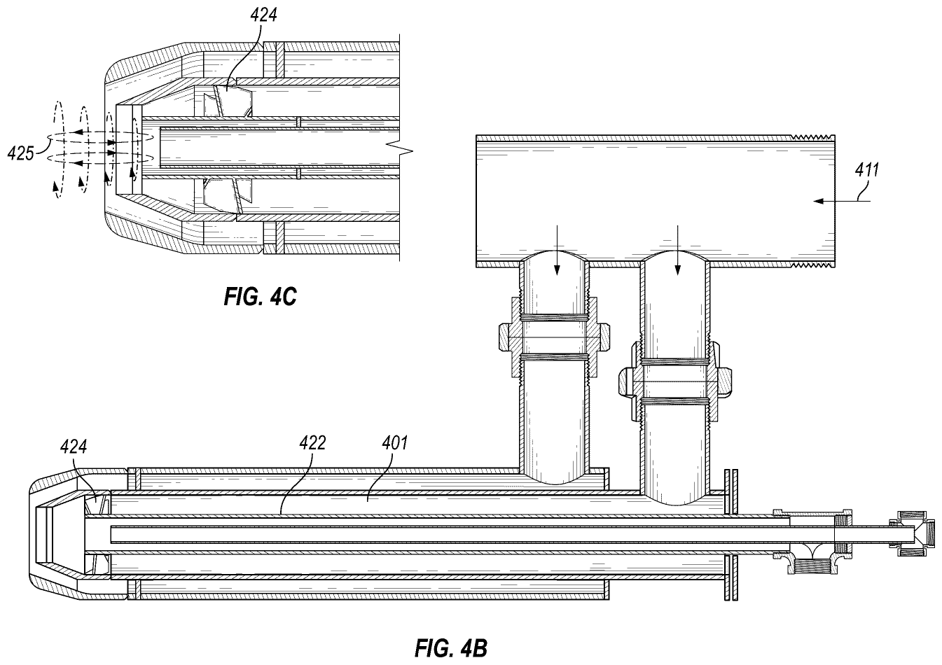

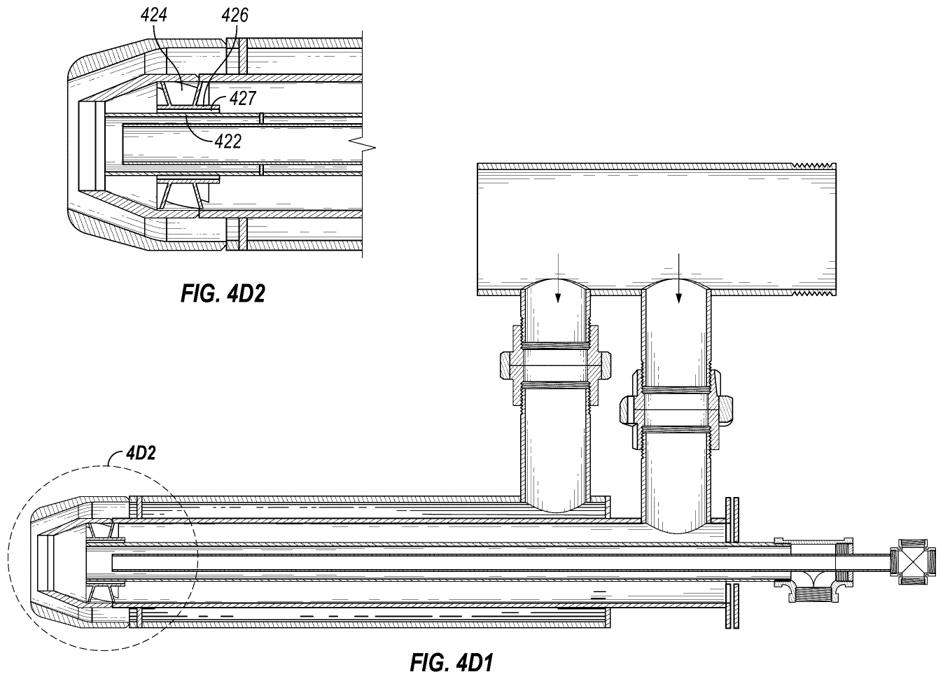

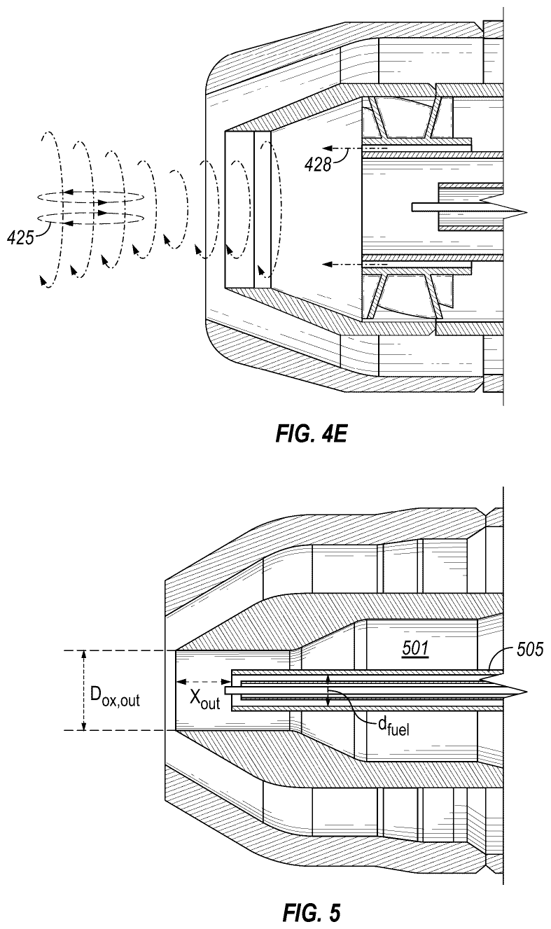

FIG. 4A shows a cross-section side schematic view of a multi-function burner according to the present disclosure with a central lance comprising an inner channel 421 and outer channel 422. The inner channel 421 of the central lance may be withdrawn relative to the outer channel 422 in the direction away from the exit plane 423 of the burner. The central lance and/or inner channel 421 may move independently along the axis of the burner. Although omitted from the drawing, the central lance may comprise an ignition source and/or a flame scanning device as in FIG. 2. The outlet of the central channel 401 may be withdrawn relative to the outlet of the annular channel 403 in the direction away from the exit plane 423 of the burner. During heating mode, heating fuel 409 may be supplied via the inner channel 421 of the central lance and heating mode oxygen 418 may be supplied via the outer channel 422 of the central lance. Air 411 may be supplied via both the central channel 401 and the annular channel 403. Delivering air via both the central channel 401 and the annular channel 403 reduce the velocity of the air flow at the exit plane 423 which both reduces the air pressure (therefore compression cost) required and reduces the risk of flame blowoff or extinction (improving flame stability).

FIG. 4B shows a modification of FIG. 4A in which one or more swirl vanes 424 are attached to the outer channel 422 of the central lance extending at least partially into the central channel 401. In at least some embodiments the one or more swirl vanes 424 may be attached to the central channel 401. In cases where the central lance comprises a single channel, the one or more swirl vanes 424 may be attached to the outermost channel of the central lance. For example, the embodiments shown in FIGS. 2A and 2B could have one or more swirl vanes attached to the central lance extending at least partially into the central channel 201. The one or more swirl vanes 424 impart a swirling flow to the air 411 in heating mode and to the oxygen in oxy-fuel mode which improves mixing in the flame.

FIG. 4C zooms in on the tip of the multi-function burner of FIG. 4B to show the effect of the one or more swirl vanes 424 on the flame. In the oxy-fuel mode, the swirl imparted to the oxygen flowing through the central channel creates radial expansion of the flame which in turn generates an internal or central flow recirculation zone 425 within the flame. The recirculation has a positive effect through improving mixing which reduces soot formation in the flame and minimizes flame length, however there is risk that the recirculation may cause the flame to be pulled so far back towards the tip of the multi-function burner that the flame impinges on the metal of the multi-function burner causing damage, or at the very least, increases the surface temperature and heat flux onto components of the burner nozzle relative to the non-swirled case.

An alternate embodiment of the one or more swirl vanes designed to mitigate the aforementioned risk is shown in FIG. 4D1 and zoomed in on FIG. 4D2. Here the one or more swirl vanes 424 are offset from the outer channel of the central lance in the radial direction. In at least some embodiments the offset is achieved by mounting the one or more swirl vanes on a hub 426 offset from the outer channel of the central lance. The annular gap 427 between the one or more swirl vanes 424 and the outer channel 422 of the central lance allows a portion of the oxygen during the oxy-fuel mode to create a slip stream bypassing the one or more swirl vanes 424.

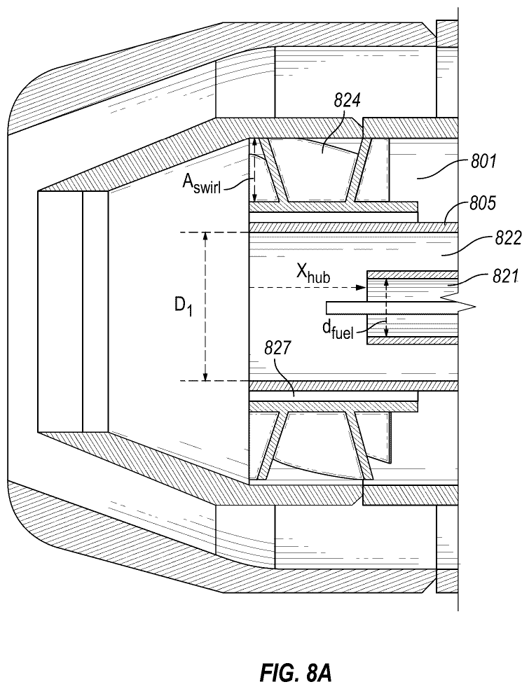

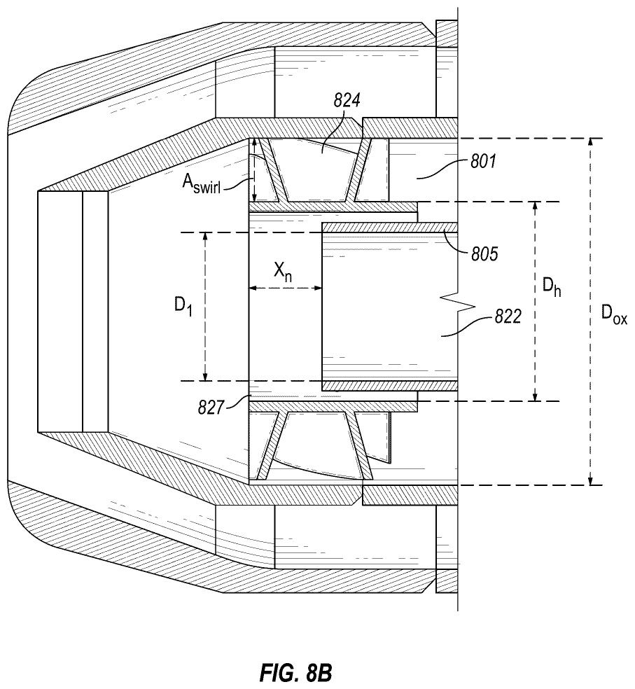

FIG. 4E zooms in on the tip of the multi-function burner of FIG. 4D to show the effect of the annular gap 427 on the flame. The slip stream 428 of unswirled oxygen reduces the magnitude of heat flux from the flame back to the multi-function burner nozzle by pushing the inner recirculation zone 425 away from the multi-function burner nozzle. The annular gap therefore reduces or eliminates the risk of impinging the flame on the multi-function burner nozzle while maintaining the benefits of improved flame mixing for reduced soot formation and flame length. The same effect may be observed with a single channel in the central lance as well (for example, see FIG. 8B).

FIG. 5 zooms in on the tip of the multi-function burner of FIG. 2 to define the key geometric parameters that governs the performance of the multi-function burner. D_{ox,out} is the inner diameter of the central channel 501 at the exit, d_{fuel} is the inner diameter of the central lance 505 at the exit, and Xₒᵤₜ is the length that the exit of the central lance 505 is withdrawn relative to the exit of the central channel 501.

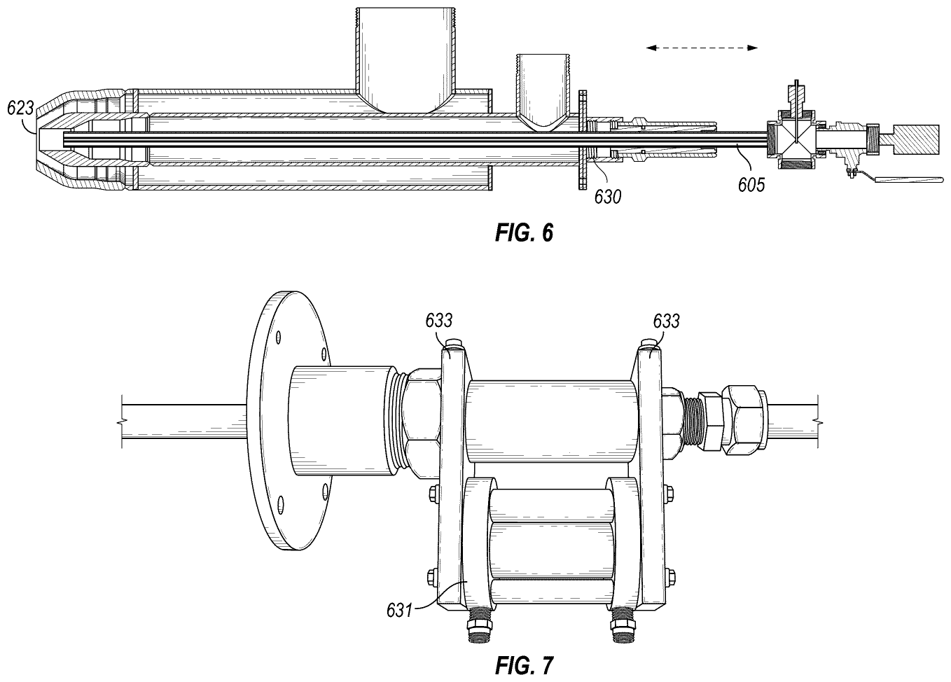

For burners wherein D_{ox,out}/d_{fuel} is less than 1.5, for example when the nozzle exit velocity of the fuel during heating mode is reduced by increasing d_{fuel} to prevent flame blowoff, the Xₒᵤₜ/d_{fuel} may be a very small value during heating mode. The risk of damaging the central lance 505 during oxy-fuel mode may be mitigated by either removing the central lance 505 during oxy-fuel mode or withdrawing the central lance 505 using a retraction mechanism at the end of heating mode. FIG. 6 shows a cross-section side schematic view of a POx burner with a central lance 605 on a drive mechanism (not shown) to move the central lance towards the multi-function burner exit plane 623 during heating mode and away from the multi-function burner exit plane 623 during oxy-fuel mode. A gasket seal 630 such as an O-ring or packing gland may be employed to prevent gas leakage around the outer wall of the central lance. FIG. 7 shows an example of a drive mechanism utilizing a pneumatic cylinder 631 to move a plate 632 fixed to the central lance relative to a plate 633 that is fixed to the multi-function burner. In at least some embodiments the drive mechanism is radially offset from the central axis of the multi-function burner so that a flame scanning device has a clear line of sight along the central lance.

FIG. 8A zooms in on the tip of the multi-function burner of FIG. 4D to define the key geometric parameters that governs the performance of the multi-function burner. D₁ is the inner diameter of the outer channel 822 of the central lance 805, d_{fuel} is the inner diameter of the inner channel 821 of the central lance 805, and X_{hub} is the length that the exit of the inner channel 821 of the central lance 805 is withdrawn relative to the exit of the outer channel 822 of the central lance 805. A_{swirl} is the cross-sectional flow area of the one or more swirl vanes 824 and A_{gap} is the cross-sectional flow area of the annular gap 827. In at least some embodiments the ratio of A_{gap}/A_{swirl} ranges from 0.05 to 0.75, or from 0.1 to 0.5.

FIG. 8B is a modification of FIG. 8A in which the central lance 805 has a single channel and is withdrawn from the outlet of the central channel 801. The length from the outlet of the central lance 805 to the outlet of the central channel 801 is xₙ. The diameter of the outlet of the central lance 805 is D₁. Values of xₙ/D₁ ranging from 0.25 to 2.0 may improve the development of a flame jet, reducing the risk of substantial radial flame expansion prior to the flame exiting the multi-function burner nozzle and entering the reactor. The one or more swirl vanes 824 may be fixed to the outer wall of the central channel 801 and fixed to the outer surface of a circumferential hub. In cases where a circumferential hub is used to mount the one or more swirl vanes 824, the annular gap may be defined as the space between the circumferential hub and the central lance 805. Just as in FIG. 8A, in at least some embodiments the ratio of A_{gap}/A_{swirl} ranges from 0.05 to 0.75, or from 0.1 to 0.5. The diameter of the hub is Dn. The diameter of the central channel in which the one or more swirl vanes 824 may be mounted is Dₒₓ. The central lance 805 may terminate in a wider section of the central channel 801 than the outlet of the central channel 801, that is the cross-sectional flow area of the central channel 801 immediately downstream of the outlet of the central lance 805 may be greater than the cross-sectional flow area of the central channel 801 at the outlet of the central channel 801. The central lance 805 may terminate at a axial position upstream of the outlet of the circumferential hub. The central lance 805 may terminate at an axial position downstream of the inlet of the circumferential hub.

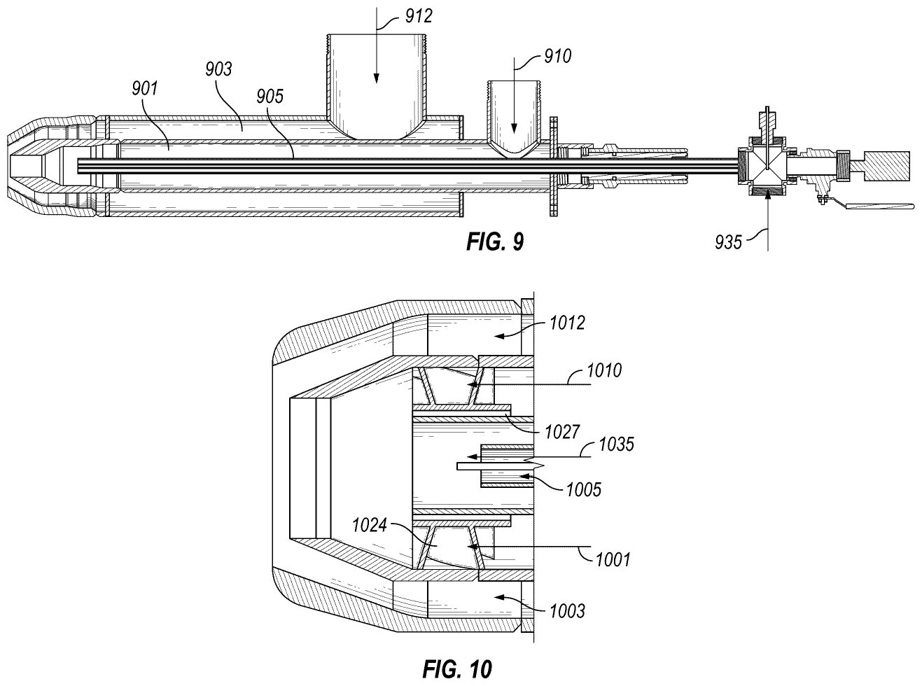

While in oxy-fuel mode, the central lance may provide another source of fuel as shown in FIG. 9. In this configuration the primary fuel 912 is supplied through the annular channel 903 and oxygen 910 through the central channel 901 as before. However, instead of withdrawing, removing, or isolating the central lance 905, the central lance 905 delivers an auxiliary fuel 935 to the multi-function burner. In at least some embodiments the auxiliary fuel 935 has a higher heating value than the primary fuel 912. In at least some embodiments the auxiliary fuel 935 is a gaseous-phase fuel and the primary fuel 912 is a liquid-phase hydrocarbon and/or a solid-phase hydrocarbon in a liquid slurry. The auxiliary fuel 935 may stabilize the combustion of the primary fuel 912 and/or reduce soot formation. The beneficial effects may be particularly significant when the primary fuel 912 is operating in a turndown mode where the flow rate of primary fuel 912 is less than 50%, or less than 20% of the burner's design value for oxy-fuel mode. Ordinarily, a prior art POx burner in turndown mode suffers from low momentum causing incomplete mixing and poor flame penetration into the reactor which results in high soot formation and low carbon conversion efficiency, where carbon conversion efficiency is defined as 100% minus the percentage of unreacted primary fuel. However, we have found that when used in combination with any embodiment of the multi-fuel burner, the auxiliary fuel-enabled burner of FIG. 9 produces very low soot formation and high carbon conversion efficiency across a wide range of primary fuel flow rates in either gas, liquid, solid, or any combination of phases. The use of an auxiliary fuel 935 may also be especially effective when the primary fuel is difficult to ignite and burn such as petroleum coke, anthracite coal, high moisture fuels or gaseous fuels with higher heating value less than about 500 Btu/scf. There may be numerous other beneficial uses of auxiliary fuel that are not specifically identified herein.

FIG. 10 shows a cross-section side view schematic of an multi-function burner in which an auxiliary fuel 1035 in the gas phase is supplied via the central lance 1005, oxygen 1010 via the central channel 1001, and primary fuel 1012 in the annular channel 1003. The primary fuel 1024 may be liquid hydrocarbon, a solid hydrocarbon in a liquid slurry, or a combination of the two. The central channel comprises one or more swirl vanes 1024 with an annular gap 1027 to improve flame mixing without impinging the flame on the multi-function burner tip. The combination of the gas-phase auxiliary fuel 1035 with the one or more swirl vanes 1024 in the central channel 1001 greatly improves the combustion efficiency of liquid and/or solid hydrocarbons, which is a common challenge in POx reactors.

Any of the multi-function burners described in the present disclosure may be used in two modes: a heating mode to bring the POx reactor above the auto-ignition temperature of the primary fuel, and an oxy-fuel mode to partially oxidize the primary fuel into syngas.

The heating mode comprises the following steps: igniting a heating fuel in the presence of oxygen to produce a flame, surrounding the flame with flowing air, detecting the presence of the flame with a flame scanning device, measuring the temperature of a POx reactor (which may be a single temperature measurement of the furnace refractory or an average of temperature measurements from different locations within the reactor), and adjusting the flow rate of the heating fuel and oxygen to achieve a desired temperature vs time relationship. In at least some embodiments, the multi-function burner is operated at or near light-off with an excess of oxygen from both air and/or oxygen streams. The equivalence ratio of the multi-function burner is defined as the ratio of fuel to oxygen divided by the stoichiometric ratio of fuel to oxygen, where both fuel and oxygen are defined as the total amount of fuel and oxygen introduced to the multi-function burner through all channels, for example both air and oxygen streams. Fuel-rich flames have an equivalence ratio greater than one and fuel-lean flames have an equivalence ratio less than one. The equivalence ratio of the multi-function burner during heating mode may be less than 0.5, or less than 0.4, or less than 0.3. In at least some embodiments, the equivalence ratio is gradually increased as the temperature of the POx reactor increases, but is kept below 1 during the heating mode. Specifically, while the equivalence ratio may be controlled by changing the flow rate of air, oxygen, and/or heating fuel, in at least some embodiments, only the flow rate of the heating fuel is changed to control the equivalence ratio. This is done in order to minimize the change in the overall flow rate of the multi-function burner, which is predominantly associated with the air flow. Hence, by maintaining a nominally constant air flow rate, the flame momentum and, hence, heat distribution, remains essentially constant throughout the heating mode. Moreover, it has been found that it is possible to ensure flame stability with essentially a fixed oxygen flow rate throughout the heating mode. Therefore it is optimal to control reactor heating and flame stability simultaneously by setting both the air flow rate and oxygen flow rate at an approximately fixed value shortly after flame ignition in the heating mode, while varying the fuel flow rate (and, indirectly, equivalence ratio). Varying the equivalence ratio in this prescribed manner during the heating mode improves the controllability of the POx reactor temperature as a function of time compared to a method in which the equivalence ratio is kept constant and the total flow rate through the multi-function burner substantially changes.

When the temperature of the POx reactor is substantially above the auto-ignition temperature of the primary fuel (for example high enough to stay above the auto-ignition temperature of the primary fuel after switching burner modes and pressurizing the reactor), the multi-function burner may be switched from heating mode to oxy-fuel mode by first shutting off the supply of air, oxygen, and heating fuel. The temperature at which the multi-function burner may be switched is determined by process operating requirements and may exceed 1100° C. or 1400° C. The annular channel of the multi-function burner is then reconfigured to accept a primary fuel flow, for example by closing one or more valves on the supply of air and opening one or more valves on the supply of primary fuel flow. Lines may be purged with inert gas as required, for example when a line is switching from fuel to air or vice versa.

In at least some embodiments, the supply of heating fuel is then disconnected or positively isolated from the multi-function burner. The multi-function burner can then be restarted by flowing primary fuel through the annular channel and oxygen through the central channel. At least a portion of the oxygen may be contacted with one or more swirl vanes to impart a swirl motion to the oxygen. The equivalence ratio of the multi-function burner during oxy-fuel mode may range from 2.5 to 5.0. As the reactor is above the auto-ignition temperature of the primary fuel, this will produce a flame in the reactor. The reactor may then be pressurized to the operating pressure for oxy-fuel mode, typically greater than or equal to 10 bar. The oxy-fuel mode continues with the reacting of the primary fuel with oxygen at a temperature greater than the auto-ignition temperature and an elevated pressure to produce syngas.

In at least some embodiments, when the multi-function burner transitions from heating mode to oxy-fuel mode, the heating fuel is replaced with an auxiliary fuel. In cases where the auxiliary and heating fuels are from the same source no change would be required. When employing an auxiliary fuel, the oxy-fuel mode further comprises energizing an ignition source in proximity to the exit plane of the central lance, wherein the exit plane of the central lance is withdrawn upstream from the exit plane of the central channel by an amount, Xₒᵤₜ/d_{fuel}, as defined in FIG. 5. The auxiliary fuel flowing through the central lance forms a flame immediately adjacent to the outlet of the central lance. Note that ignition of the auxiliary fuel upstream of the central channel exit is critical to ensure the auxiliary fuel benefits denoted herein. The firing rate of the auxiliary fuel may be controlled to range from 5% to 25% of the firing rate of the primary fuel. The firing rate is defined herein as the fuel flow rate times the fuel heating value (i.e. higher heating value, HHV, or lower heating value, LHV). The auxiliary fuel may be preferentially used when the total firing rate of fuel through the multi-function burner is less than or equal to 50% of the design rate, or less than or equal to 20% of the design rate. The auxiliary fuel may be the same composition as the primary fuel. The auxiliary fuel may be in the gas phase and the primary fuel may be in the gaseous, liquid and/or solid phase.

In some embodiments, the multi-function burner may not require any hardware transition from an oxidizing environment in the heating mode to a reducing environment in the oxy-fuel mode. With the multi-function burner at or slightly above atmospheric pressure, the heating method may begin by injecting oxygen in the central channel and auxiliary fuel in the central lance in a sub-stoichiometric ratio to maintain a reducing atmosphere. The equivalence ratio of the auxiliary fuel to oxygen may be maintained below 1, i.e. fuel-lean. The flame may be initialized by energizing the ignition source close to the exit of the burner, either before or after the initiation of oxygen and central fuel flow. At this point the flame may be verified by the flame scanning device. Primary fuel may next be supplied to the annular channel such that the overall equivalence ratio of primary fuel and auxiliary fuel to oxygen is less than 1, (fuel lean) and/or the flow rate of auxiliary fuel may be greater than the flow rate of primary fuel. The reactor may be pressurized or remain at near atmospheric pressure by proportionally increasing the auxiliary fuel, primary fuel, and oxygen at the same sub-stoichiometric ratio to increase the heat duty of the burner, and to maintain the constant reducing atmosphere during the reactor heat up procedure. The flame scanning device and/or ignition source may be isolated from the reactor to prevent damage from the pressure increase. When the reactor temperature reaches a target temperature, the heating mode may be seamlessly transitioned to the startup of the oxy-fuel mode by increasing the flow rate of the primary fuel to increase the overall equivalence ratio of primary fuel and auxiliary fuel to oxygen to be greater than 1 (fuel rich). The target temperature may be the auto-ignition temperature of the primary fuel. The target temperature may range from 1100° C. to 1400° C. The auxiliary fuel, primary fuel, and oxygen mass flow rates may be proportionally increased with reactor pressure to maintain approximately constant velocities in the burner and approximately constant gas residence time in the reactor. This may avoid any upset due to sudden increase in throughput and pressure in the system, two ill effects which may be caused by the prior art methods of transitioning from an oxidizing environment in heating mode to a reducing environment in oxy-fuel mode. The seamless transition from heating mode to oxy-fuel mode described above may minimize formation of solid carbon byproducts when compared to the prior art methods which may cause a sudden large increase in throughput leading to high velocities and low residence time during the startup of oxy-fuel mode, often fouling the downstream equipment such as the waste heat boiler. A person of skill in the art will appreciate the safety and performance benefits provided by eliminating the need to switch from the oxidizing heating mode to the reducing startup oxy-fuel mode.

During oxy-fuel mode, the flow of auxiliary fuel through the central lance may continue. By reacting auxiliary fuel with the oxygen flowing through the central channel, such that the auxiliary fuel-oxygen mixture is fuel-lean (having an equivalence ratio less than 1.0) the mixture containing excess oxygen may be heated to a greater extent than could be achievable by known preheating methods upstream of the oxy-fuel burner. The resulting heated mixture stream may then experience a rapid increase in velocity due to its elevated temperature and consequently lower density, and serve as a much more efficient oxidizer of the primary fuel, drastically reducing soot production, increasing conversion of the primary fuel to syngas, and optimizing gasification product distribution. The heated mixture may also allow low-value feedstock to be consumed in the reactor such as biogas or low heating value syngas. The feed injector may have enhanced turndown capability due to the use of heated auxiliary fuel-oxygen mixture. The flow rate of primary fuel may be decreased to decrease the overall equivalence ratio of primary fuel and auxiliary fuel to oxygen to be less than 1, allowing the reactor to return to a heating mode or go into a standby mode. The flow rate of primary fuel may be decreased to less than 50%, or less than 20% of the burner's design value for oxy-fuel mode. The flow rate of primary fuel may be decreased to decrease the temperature of the furnace below the auto-ignition temperature of the primary fuel. This method of operation would allow continuous cycling from a heating mode to an operating mode an back without having to remove or replace a separate preheating burner.

In at least some embodiments, a moderator such as steam or carbon dioxide may be introduced to the burner to reduce NOx emissions. Any channel may be used to inject the moderator including the central lance, the annular channel, and/or an additional channel outside of the annular channel.

Swirl vanes as disclosed herein may also be utilized by oxy-fuel burners without the multi-function feature enabled by the central lance. The general concept of imparting a swirling motion on a portion of the oxygen flow to improve mixing in the flame while also bypassing a portion of the oxygen flow closer to the centerline of the burner to push the recirculation zone away from the nozzle tip will provide benefits to any oxy-fuel burner. However, we have found that the physical means used to achieve these two effects may require adaptation for an oxy-fuel burner without multi-function capability.

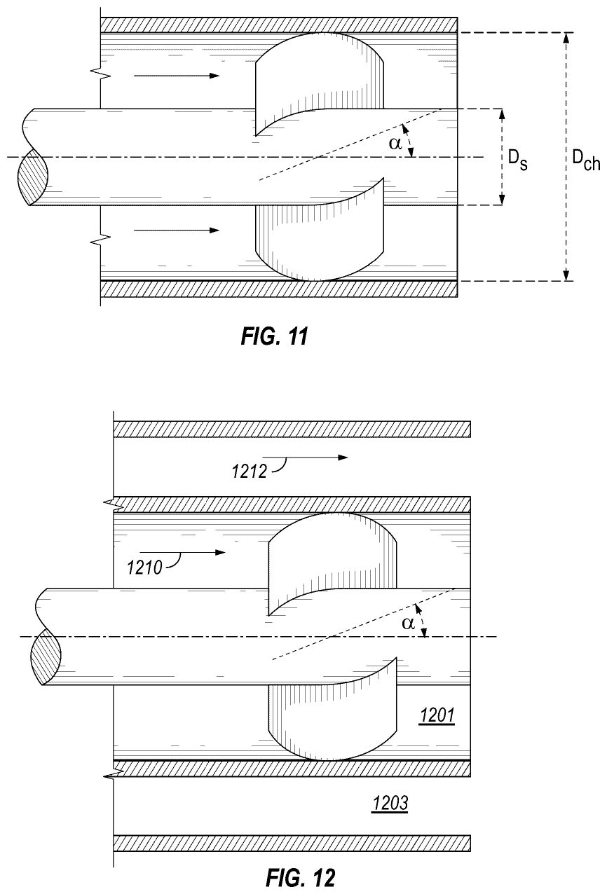

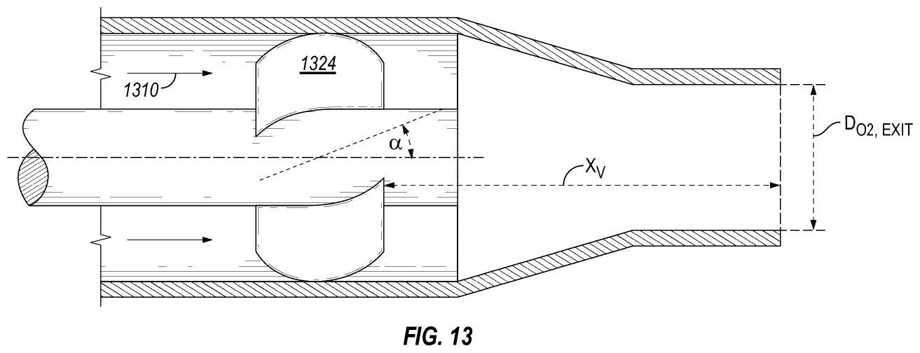

FIG. 11 shows a cross-section side view schematic of a central channel with one or more swirl vanes 1124 as described by Beér and Chigier (Combustion Aerodynamics, 1983) for an air-fuel burner. The one or more swirl vanes 1124 are mounted on a shaft with a diameter Dₛ and the diameter of the central channel is D_{ch}. FIG. 12 shows a modification of FIG. 11 in which the central channel 1201 may be used to deliver oxygen 1210 to an inverse diffusion oxy-fuel burner where it is combined with fuel 1212 delivered through a surrounding annular channel 1203. Two deficiencies exist in the central channels depicted by FIGS. 11 and 12. One deficiency is the propensity for thermally-induced damage to the swirl vanes caused by heating from the extremely high temperature oxy-fuel flame. We have found that this deficiency is remedied by withdrawing the swirl vanes from the exit plane of the oxygen nozzle to a plane of larger cross-sectional area, such as by employing a converging nozzle as depicted in FIG. 13. The withdrawn, converging nozzle exit of FIG. 13 effectively shields the swirl vanes 1324 from a substantial portion of the flame radiation, as relatively cool oxygen 1310 flows past it. We further note that while the convergent nozzle of FIG. 13 is symmetric, in at least some embodiments the convergence may be asymmetric, i.e. the walls may angle inwards by a lesser degree or not at all on one or more sides of the channel. In at least some embodiments the convergence may be an abrupt transition with 90° corners to transition to a smaller cross-sectional area. In at least some embodiments the convergence may be curved instead of linear.

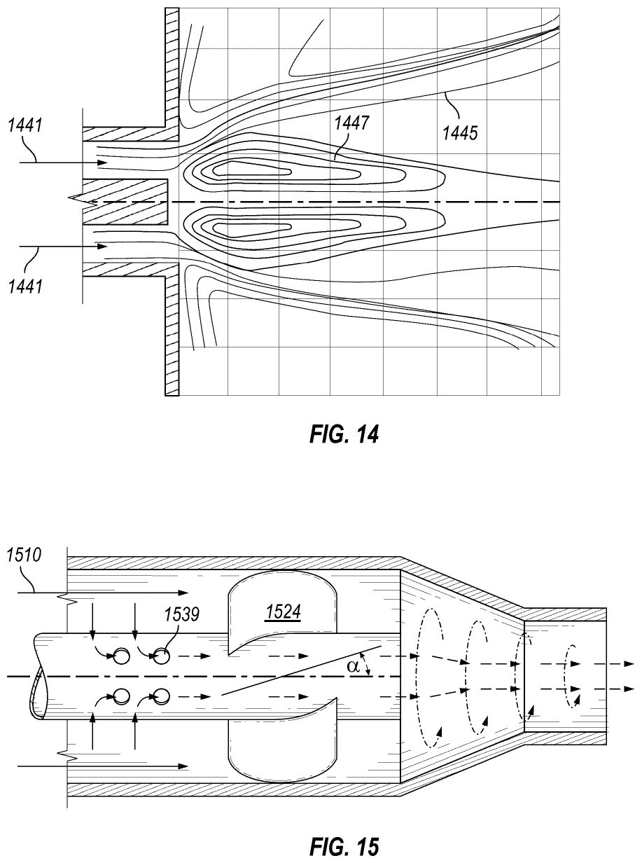

Prior to describing the second deficiency, we note that each swirl vane may be deflected from the axis of the central channel by a swirl angle α, which may be the same for each swirl vane or one or more swirl vanes may have different swirl angles. The one or more swirl vanes may be attached to a central shaft which may be solid or hollow. The one or more swirl vanes may terminate upstream of the reduction in cross-sectional area. The distance from the termination of the one or more swirl vanes and the converging nozzle exit is defined as Xᵥ, and the diameter of the converging nozzle exit is defined as D_{O2,exit}. In at least some embodiments the ratio Xᵥ/D_{O2,exit} is less than or equal to 10, thus preventing substantial loss of swirl strength due to viscous dissipation. We further note that the strength of the swirl imparted to the fluid in the central channel may be quantified using the Swirl number S, defined as the ratio of the axial flux of the angular momentum G_{φ} to the product of the axial thrust Gx and the exit radius R of the burner nozzle. When S=G_{φ}/GₓR is less than 0.6, the fluid is in the weak swirl regime, and when S is greater than 0.6 the fluid is in the strong swirl regime. According to Beer and Chigier, systems in the weak swirl regime are unable to cause internal recirculation and therefore flames in the weak swirl regime “have only a limited practical interest.” FIG. 14 shows streamlines for a flow field with a swirling jet with S equal to 1.57. In this strong swirl regime, an internal recirculation zone (IRZ) can be clearly seen that both improves mixing within a flame and extends upstream to a location very close to the exit plane where axial distance equals 0.

With respect to the prior art, we assert that the basis for utilization of swirl is principally in air-fuel combustion where flame temperatures are generally of the order of 1000° C. lower than those produced by oxy-fuel combustion as applied to the present invention. Further, whereas the characteristic IRZ depicted in FIG. 14 may be suitable or strongly desirable in some air-fuel flames, the proximity of the upstream tip of the IRZ to the burner nozzle would be prone to cause overheating of the nozzle if applied to oxy-fuel combustion. This is the second deficiency of the prior art. That is, while the presence of an IRZ is indeed beneficial in that it enhances reactant mixing, improving carbon conversion efficiency and minimizing soot formation within the flame, the upstream location of the IRZ adjacent the nozzle exit is not acceptable for a broad category of oxy-fuel flames.

FIG. 15 shows a modification of FIG. 11 with one or more bleed holes located upstream of the one or more swirl vanes. The central shaft is hollow, allowing fluid 1510 to travel from the central channel into the one or more bleed holes 1539 and out of the central shaft nozzle exit, thus bypassing the one or more swirl vanes 1524. The bypass of the one or more swirl vanes 1524 makes it possible to achieve the benefits of improved mixing in the flame while mitigating the risk of pushing the flame back onto the burner. The central channel may be configured to deliver either fuel or oxygen, with the surrounding annular channel configured to deliver oxygen or fuel, respectively. We have found the use of properly configured bleed holes into a hollow shaft, in combination with the converging oxygen nozzle, to be the most effective system for attaining the swirl benefits while avoiding the aforementioned deficiencies. This is because a) the oxygen bleed flow exits the shaft essentially along the longitudinal axis of the burner and b) upon exit from the shaft is accelerated within the convergent section. Hence, even a relatively small bleed flow rate (compared to the total oxygen flow in the nozzle) has an amplified effect in opposing back propagation of the IRZ, which is also centered along the burner axis.

The driving force for the bleed flow is the back pressure generated by the one or more swirl vanes, which forces a fraction of the fluid flow through the central channel into the one or more bleed holes. The value of the fraction will be a function of the number and size of the one or more holes, the number of swirl vanes, the swirl vane angle α, the position of the one or more holes with respect to the position of the one or more swirl vanes, the cross-sectional area of the central channel at the one of more swirl vanes, the cross-sectional area of the central channel at the nozzle exit, and the total flow rate of fluid in the central channel. In at least some embodiments, the total flow rate through the one or more bleed holes ranges from about 1% to 50%, or from 5% to 25% of the total flow rate through the central channel upstream of the one or more bleed holes.

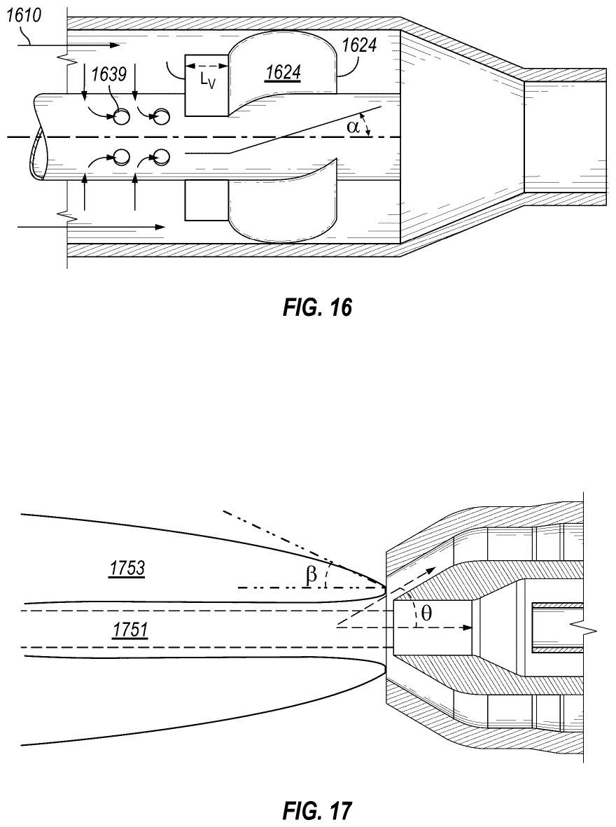

FIG. 16 shows a modification of FIG. 15 in which the one or more swirl vanes has a varying swirl vane angle over the length of the one or more swirl vanes. The trailing edge 1651 of the one or more swirl vanes 1624 may have a swirl vane angle of a. The leading edge 1652 of the one or more swirl vanes 1624 may have a swirl vane angle less than a. In the embodiment shown in FIG. 16 there is a section beginning at the leading edge 1652 with length Ly and swirl vane angle of zero. In at least some embodiments the swirl vane angle may change gradually from the leading edge 1652 to the trailing edge 1651.

Aspect 1: A multi-function burner comprising a tip configured to discharge a flame into a reactor; a central lance configured to deliver at least one fluid to the reactor through an exit plane; a central channel surrounding the central lance configured to deliver at least one fluid to the reactor through an exit plane; an annular channel surrounding the central channel configured to deliver at least one fluid to the reactor through an exit plane.

Aspect 2: A multi-function burner according to Aspect 1, wherein the central lance comprises an ignition device configured to ignite a flame near the end of the central lance.

Aspect 3: A multi-function burner according to Aspect 1 or Aspect 2, wherein the outlet of the annular channel forms an angle θ with respect to a central axis of the multi-function burner less than about 45°.

Aspect 4: A multi-function burner according to any of Aspects 1 to 3, wherein a cross-sectional flow area of the central channel immediately downstream of the outlet of the central lance is greater than the cross-sectional flow area of the central channel at the outlet of the central channel.

Aspect 5: A multi-function burner according to any of Aspects 1 to 4, wherein the central lance comprises an inner channel and an outer channel.

Aspect 6: A multi-function burner according to any of Aspects 1 to 5, wherein the annular channel is configured to switch between fluid sources during operation of the multi-function burner.

Aspect 7: A multi-function burner according to any of Aspects 1 to 6, wherein the central channel comprises one or more swirl vanes configured to impart a swirling motion on at least a portion of fluid traveling through the central channel.

Aspect 8: A multi-function burner according to Aspect 7, wherein the central channel comprises an annular gap located between the central lance and the one or more swirl vanes configured to bypass a portion of the fluid traveling through the central channel around the one or more swirl vanes.

Aspect 9: A multi-function burner according to Aspect 8, wherein a ratio of cross-sectional flow area of the annular gap to cross-sectional flow area of the one or more swirl vanes ranges from 0.05 to 0.75.

Aspect 10: A multi-function burner according to Aspect 8 or Aspect 9, further comprising a circumferential hub; wherein the one or more swirl vanes are fixed to an outer wall of the central channel and an outer surface of the circumferential hub; wherein the annular gap is defined as the space between the circumferential hub and the central lance.

Aspect 11: A multi-function burner according to Aspect 10, wherein the central lance terminates at an axial position upstream of an outlet of the circumferential hub.

Aspect 12: A method for operating a multi-function burner comprising a heating mode and an oxy-fuel mode; wherein the heating mode comprises feeding air through an annular channel, feeding oxygen through a central channel within the annular channel, and feeding a heating fuel through a central lance within the central channel to produce a flame extending into a furnace having a temperature; wherein the heating mode switches to the oxy-fuel mode after the furnace temperature exceeds the auto-ignition temperature of a primary fuel; and wherein the oxy-fuel mode comprises feeding the primary fuel through the annular channel and feeding oxygen through the central channel within the annular channel.

Aspect 13: A method according to Aspect 12, further comprising contacting at least a portion of the oxygen with one or more swirl vanes.

Aspect 14: A method according to Aspect 13, further comprising bypassing a portion of the oxygen through an annular gap located between the one or more swirl vanes and the central lance.

Aspect 15: A method according to any of Aspects 12 to 14, wherein the central lance is withdrawn in an axial direction away from the tip of the multi-function burner when the heating mode is switched to the oxy-fuel mode.

Aspect 16: A method for operating a multi-function burner comprising feeding primary fuel through an annular channel, feeding oxygen through a central channel within the annular channel, and feeding an auxiliary fuel through a central lance within the central channel to produce a flame extending into a furnace having a temperature and a pressure; wherein an equivalence ratio of the auxiliary fuel to oxygen is maintained below 1.

Aspect 17: A method according to Aspect 16, further comprising increasing the flow rate of the primary fuel to increase an overall equivalence ratio of primary fuel and auxiliary fuel to oxygen to be greater than 1.

Aspect 18: A method according to Aspect 17, wherein the increase in flow rate of the primary fuel occurs after the furnace temperature exceeds the auto-ignition temperature of the primary fuel.

Aspect 19: A method according to any of Aspects 16 to 18, further comprising decreasing the flow rate of the primary fuel to decrease an overall equivalence ratio of primary fuel and auxiliary fuel to oxygen to be less than 1.

Aspect 20: A method according to Aspect 19, wherein the decrease in flow rate of the primary fuel decreases the furnace temperature below the auto-ignition temperature of the primary fuel.

Aspect 21: A method according to Aspect 19 or Aspect 20, wherein the flow rate of the primary fuel is decreased to below 50% of a design value for the flow rate of the primary fuel.

Aspect 22: A method according to any of Aspects 16 to 21, wherein the flow rates of oxygen, primary fuel, and auxiliary fuel, furnace temperature, and furnace pressure are varied to maintain an approximately constant residence time of gases within the furnace.

Aspect 23: A method according to any of Aspects 16 to 22, further comprising contacting at least a portion of the oxygen with one or more swirl vanes.

Aspect 24: A method according to Aspect 23, further comprising bypassing a portion of the oxygen through an annular gap located between the one or more swirl vanes and the central lance.

Aspect 26: An oxygen nozzle comprising a hollow central shaft comprising one or more swirl vanes and one or more bleed holes positioned upstream of the one or more swirl vanes; a central channel surrounding the central lance configured to deliver oxygen to the reactor through an exit plane; wherein the cross-sectional area of the central channel where the one or more swirl vanes terminate is greater than the cross-sectional area of the central channel at the exit plane of the central channel.

Aspect 27: An oxygen nozzle according to Aspect 26, wherein the one or more bleed holes are configured to deliver a flow rate of oxygen through the one or more bleed holes ranging from about 1% to 50% of the total flow rate of oxygen through the central channel upstream of the one or more bleed holes.

Aspect 28: An oxygen nozzle according to Aspect 26 or Aspect 27, wherein the one or more swirl vanes comprise a leading edge and a trailing edge with respect to the flow direction of oxygen; and wherein a swirl angle at the trailing edge of the one or more swirl vanes is greater than a swirl angle at the leading edge of the one or more swirl vanes.

### Examples

Oxy-fuel burners were built with central channels according to both FIG. 13 (solid wall) and FIG. 15 (bleed hole). Through simple hardware changes, the “bleed hole” burner was configured to deliver either approximately 10 or 15% of the total oxygen flow through the one or more bleed holes. Over a broad range of designs and operating conditions of commercial interest, the “bleed hole” burner flame front was, in contrast to that of the “solid wall” burner, was both stable and separated from the nozzle tip. Compared to the “solid wall” burner, the “bleed hole” burner is able to provide lower surface temperatures at the burner nozzle, lower heat flux delivered to the burner surface, lower surface temperature on the one or more swirl vanes, reduced burner noise, improved flame stability, and more predictable burner performance. Furthermore, it was found that even when the introduction of bleed holes to the burner design would drop the Swirl number S below 0.6 cited by Beer and Chigier for air-fuel flames, the flame was still able to generate an IRZ. It is possible that the formation of the IRZ is due to the much more rapid flame expansion occurring in swirling oxy-fuel combustion relative to swirling air-fuel combustion, thus suggesting new design principles are needed for swirl flow in oxy-fuel flames.

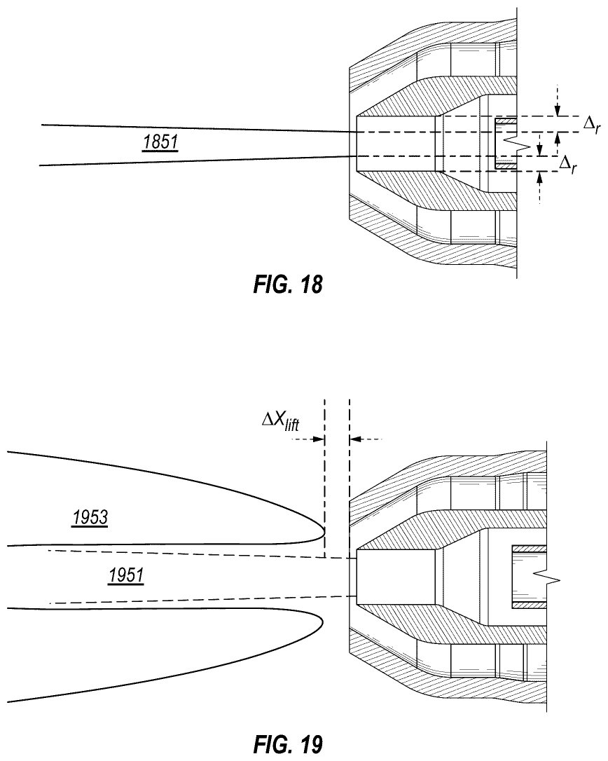

Three embodiments of the present disclosure were tested experimentally: a no swirl case using a burner as shown in FIG. 2, a full swirl case and a partial swirl case using a burner as shown in FIG. 8B. Both the full swirl case and partial swirl case used vanes with a swirl angle of 42.5°. The partial swirl case had a ratio of A_{gap}/A_{swirl} of 0.3 and xₙ/D₁=1. The full swirl case can be described as FIG. 8B with A_{gap}/A_{swirl}=0 and xₙ/D₁=0. All three burners had a converging angle θ equal to 30° and utilized natural gas for both primary and auxiliary fuel. FIG. 17 shows a drawing of an example flame from testing with an inner flame 1751 and an outer flame 1753. The outer flame angle, B, may be defined as the angle between the outside edge of the outer flame 1753 and the burner axis. FIG. 18 shows the inner flame 1851 in detail. A radial nozzle flame clearance Δr may be defined as the distance between the outer edge of the inner flame 1851 and the inner edge of the outlet of the central channel. FIG. 19 shows an outer flame that has lifted off of the exit plane of the burner. A flame liftoff distance, ΔX_{lift}, may be defined as the axial distance from the exit plane of the burner and the beginning of the outer flame. Performance indices measured included the wall temperature near the tip of the nozzle Tₜᵢₚ, measured in the central channel at a Xₒᵤₜ/D_{ox,out} value of 0.33, outer flame angle β, radial nozzle flame clearance Δr, and flame liftoff distance ΔX_{lift}.

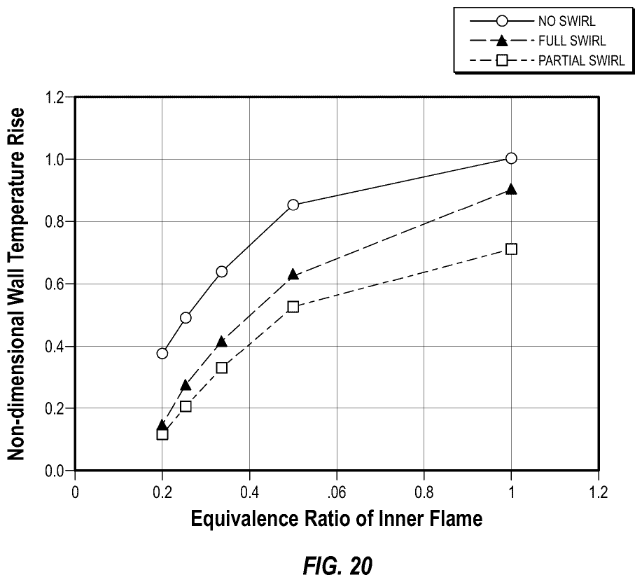

FIG. 20 shows the non-dimensionalized wall temperature (Tₜᵢₚ−T_{oxygen})/(Tₜᵢₚₘₐₓ−T_{oxygen}) as a function of the equivalence ratio in the inner flame, where T_{oxygen} is the temperature of the oxygen fed to the burner and Tₜᵢₚₘₐₓ is the maximum wall temperature observed over the course of the experiments. It may be noted that all central channel configurations confirm the same trend of temperature increasing with inner flame equivalence ratio as the equivalence ratio approaches unity from the (fuel) lean side. This is because the flame temperature increases during this trend, while the amount of unreacted “cool” oxygen around the flame periphery is reduced due to consumption by the fuel. More to the point of comparison, we note that, unexpectedly, the partial swirl design shows systematically lower nozzle tip temperature than either the full swirl or no swirl designs, and the highest temperature occurs for the no swirl case. By way of explanation, we first note that one effect of the presence of oxygen swirl is to increase the oxygen velocity exiting the central channel. To the extent that some cool, i.e. unreacted, oxygen remains, the higher oxygen velocity will enhance the convective cooling of the nozzle tip. This explains why the tip temperature of the nozzle without swirl is the highest of the 3, but does not help to explain the fact that the lowest temperature occurred with the partial swirl design. One possible explanation is related to the delayed mixing between the inner flame and the (outer) swirl portion of oxygen flowing within the “hybrid” partial swirl nozzle. This delay may be facilitated by the circumferential hub separating the axial flow and swirling flow portions of the oxygen stream and may be further amplified by the axial positioning of the central auxiliary fuel lance, whose exit plane is located upstream of the exit plane of the circumferential hub. The effects of the delay would be to reduce the rate at which the auxiliary fuel is burned within the nozzle and to increase the fraction of unreacted “swirled” oxygen leaving the nozzle, with the result being enhanced cooling of the nozzle tip.

Radial nozzle flame clearance Δr can be an important parameter for burner durability to prevent impingement of the flame onto the inner surfaces of the burner. High quality images were taken during testing while the equivalence ratio of auxiliary fuel to oxygen was maintained at 0.2. To facilitate the optical measurements, primary fuel was not employed during these tests. The non-dimensionalized radial nozzle flame clearance, equal to 2*Δr/D_{ox,out}, for the no swirl case was 0.34, the partial swirl case 0.36, and the full swirl case 0.25. We note that radial nozzle flame clearance is highest for the partial swirl design configuration and lowest for the full swirl configuration. Radial nozzle flame clearance is driven by mixing rate between the auxiliary fuel and oxygen within the burner nozzle. We specifically expect that higher mixing rate will translate into smaller radial clearance between the edge of the flame and the inner wall of the nozzle. The results therefore suggest that the full swirl case will have the highest rate of mixing of oxygen and auxiliary fuel prior to discharge from the nozzle and the partial swirl case to have the lowest. This, again, would be an unexpected result was it not for the previous nozzle temperature results and accompanying explanation. That is, it was argued that the combination of increased oxygen velocity of the swirled fraction and axial/radial separation between the axial and swirled oxygen flow portions both slowed down the auxiliary fuel consumption rate and increased the convective cooling of the oxygen nozzle. Hence the lower fuel consumption rate as deduced and the wall temperature as measured is consistent with the larger radial nozzle flame clearance for the partial swirl case compared to the full swirl case.

The outer flame angle β is known to indicate the rate of heat transfer from the flame to the burner nozzle and, as such, is one of the determinants of burner durability in service. Larger values of β may correspond to greater rate of heat transfer from the flame to the burner nozzle and shorter burner lifetimes. The equivalence ratio of the auxiliary fuel/oxygen streams was 0.2 and the equivalence ratio of the composite reactant streams; primary fuel, auxiliary fuel and oxygen, was 1.0. The outer flame angle β for the no swirl case was 23.4°, the partial swirl case 15.4°, and the full swirl case 27.0°. The initial rate of spreading of a jet flame issuing from a burner nozzle is strongly influenced by both the mixing rate among the reactants and their subsequent rate of chemical reaction. Viewed as such, the results suggest the partial swirl design configuration to have either or both the slowest initial mixing rate and chemical reaction rate (i.e. between the primary fuel stream and the auxiliary fuel/oxygen flame). This conclusion, while again unexpected, is consistent with results previously presented herein. It is unexpected in that, for a given flow rate of reactants, one would expect the relative amount of oxygen swirl to be proportional to the rate of reactant mixing. This would suggest that the full swirl configuration would have the largest spreading angle, which it does, but also that the partial swirl would have the second highest spreading angle. The fact that the partial swirl has the lowest spreading angle must therefore be otherwise explained. When combined with the observed lower wall temperature and greater radial nozzle flame clearance for the partial swirl case, it may be concluded that under conditions of identical auxiliary fuel and oxygen flow rate, less reaction took place inside the partial swirl nozzle than in either the no swirl case or the full swirl case. This further points to the partial swirl embodiment having the lowest average central flame temperature and, hence, velocity of the different designs. Stated otherwise, the lower proportion of reaction between the auxiliary fuel and oxygen within the partial swirl nozzle yielded a lower temperature fuel-lean (oxygen-rich) flame exiting the nozzle. And the lower temperature in turn yielded a higher gas density and lower gas velocity for this same embodiment. The lower temperature would thus correspond to a slower initial reaction rate between the central flame and the primary fuel stream, while the lower jet velocity would contribute to a slower initial mixing rate between the central flame and primary fuel due to the reduced shearing between the streams.

The flame liftoff distance ΔX_{lift} is known to be related to the dynamic stability of the burner, that is a non-zero value of ΔX_{lift} may correspond to a transitional state between a stable, anchored flame (zero liftoff height) and flame blowout. Moreover, it has been observed that so-called “lifted” flames are more prone to positional oscillations that can give rise to greater temporal unsteadiness in the combustion products while also leading to greater pressure pulsations and noise relative to the behavior of anchored flames. Experiments were conducted for the worst case scenario for liftoff, with a low equivalence ratio of 0.1 for the auxiliary fuel to oxygen and a low ratio of auxiliary fuel to primary fuel of 0.125. These conditions represent the lowest thermal power and lowest temperature in the central flame and the highest momentum in the primary fuel, and therefore the greatest chance of dynamic instability in the flame. The non-dimensionalized flame liftoff distance (ΔX_{lift}/D_{ox,out}) for the no swirl case and partial swirl case was both 0.34 while for the full swirl case the value was nearly double at 0.65. The benefits of the partial swirl case seen in previous parameters therefore come without the instability penalty that the full swirl case suffers from. When the experiments were repeated with nozzles with a convergence angle θ of 0°, the non-dimensionalized flame liftoff distance for all three cases was equal to zero, indicating improved flame stability.

While the principles of the invention have been described above in connection with preferred embodiments, it is to be clearly understood that this description is made only by way of example and not as a limitation of the scope of the invention.

1. A multi-function burner comprising:
a tip configured to discharge a flame into a reactor;
a central lance configured to deliver at least one fluid to the reactor through an exit plane;
a central channel surrounding the central lance configured to deliver at least one fluid to the reactor through an exit plane; and
an annular channel surrounding the central channel configured to deliver at least one fluid to the reactor through an exit plane.

2. The multi-function burner of claim 1, wherein the central lance comprises an ignition device configured to ignite a flame near the end of the central lance.

3. The multi-function burner of claim 1, wherein the outlet of the annular channel forms an angle θ with respect to a central axis of the multi-function burner less than about 45°.

4. The multi-function burner of claim 1, wherein a cross-sectional flow area of the central channel immediately downstream of the outlet of the central lance is greater than the cross-sectional flow area of the central channel at the outlet of the central channel.

5. The multi-function burner of claim 1, wherein the central lance comprises an inner channel and an outer channel.

6. The multi-function burner of claim 1, wherein the annular channel is configured to switch between fluid sources during operation of the multi-function burner.

7. The multi-function burner of claim 1, wherein the central channel comprises one or more swirl vanes configured to impart a swirling motion on at least a portion of fluid traveling through the central channel.

8. The multi-function burner of claim 7, wherein the central channel comprises an annular gap located between the central lance and the one or more swirl vanes configured to bypass a portion of the fluid traveling through the central channel around the one or more swirl vanes.

9. The multi-function burner of claim 8, wherein a ratio of cross-sectional flow area of the annular gap to cross-sectional flow area of the one or more swirl vanes ranges from 0.05 to 0.75.

10. The multi-function burner of claim 8, further comprising a circumferential hub;
wherein the one or more swirl vanes are fixed to an outer wall of the central channel and an outer surface of the circumferential hub;
wherein the annular gap is defined as the space between the circumferential hub and the central lance.

11. The multi-function burner of claim 10, wherein the central lance terminates at an axial position upstream of an outlet of the circumferential hub.

12. A method for operating a multi-function burner comprising:
a heating mode and an oxy-fuel mode;
wherein the heating mode comprises feeding air through an annular channel, feeding oxygen through a central channel within the annular channel, and feeding a heating fuel through a central lance within the central channel to produce a flame extending into a furnace having a temperature;
wherein the heating mode switches to the oxy-fuel mode after the furnace temperature exceeds the auto-ignition temperature of a primary fuel; and
wherein the oxy-fuel mode comprises feeding the primary fuel through the annular channel and feeding oxygen through the central channel within the annular channel.

13. The method of claim 12, further comprising contacting at least a portion of the oxygen with one or more swirl vanes.

14. The method of claim 13, further comprising bypassing a portion of the oxygen through an annular gap located between the one or more swirl vanes and the central lance.

15. The method of claim 12, wherein the central lance is withdrawn in an axial direction away from the tip of the multi-function burner when the heating mode is switched to the oxy-fuel mode.

16. A method for operating a multi-function burner comprising:
feeding primary fuel through an annular channel, feeding oxygen through a central channel within the annular channel, and feeding an auxiliary fuel through a central lance within the central channel to produce a flame extending into a furnace having a temperature and a pressure;
wherein an equivalence ratio of the auxiliary fuel to oxygen is maintained below 1.

17. The method of claim 16, further comprising increasing the flow rate of the primary fuel to increase an overall equivalence ratio of primary fuel and auxiliary fuel to oxygen to be greater than 1.

18. The method of claim 17, wherein the increase in flow rate of the primary fuel occurs after the furnace temperature exceeds the auto-ignition temperature of the primary fuel.

19. The method of claim 16, further comprising decreasing the flow rate of the primary fuel to decrease an overall equivalence ratio of primary fuel and auxiliary fuel to oxygen to be less than 1.

20. The method of claim 19, wherein the decrease in flow rate of the primary fuel decreases the furnace temperature below the auto-ignition temperature of the primary fuel.

21. The method of claim 19, wherein the flow rate of the primary fuel is decreased to below 50% of a design value for the flow rate of the primary fuel.

22. The method of claim 16, wherein the flow rates of oxygen, primary fuel, and auxiliary fuel, furnace temperature, and furnace pressure are varied to maintain an approximately constant residence time of gases within the furnace.

23. The method of claim 16, further comprising contacting at least a portion of the oxygen with one or more swirl vanes.

24. The method of claim 23, further comprising bypassing a portion of the oxygen through an annular gap located between the one or more swirl vanes and the central lance.

25. An oxygen nozzle comprising:
a hollow central shaft comprising one or more swirl vanes and one or more bleed holes positioned upstream of the one or more swirl vanes;
a central channel surrounding the central lance configured to deliver oxygen to the reactor through an exit plane;
wherein the cross-sectional area of the central channel where the one or more swirl vanes terminate is greater than the cross-sectional area of the central channel at the exit plane of the central channel.

26. The oxygen nozzle of claim 25, wherein the one or more bleed holes are configured to deliver a flow rate of oxygen through the one or more bleed holes ranging from about 1% to 50% of the total flow rate of oxygen through the central channel upstream of the one or more bleed holes.

27. The oxygen nozzle of claim 25, wherein the one or more swirl vanes comprise a leading edge and a trailing edge with respect to the flow direction of oxygen; and
wherein a swirl angle at the trailing edge of the one or more swirl vanes is greater than a swirl angle at the leading edge of the one or more swirl vanes.
